(19) United States
(12) Patent Application Publication
(10) Pub. No.: US 2019/0252714 A1
(43) Pub. Date: Aug. 15, 2019

(54) FUEL CELL SYSTEM

(71) Applicant: HONDA MOTOR CO., LTD., Tokyo (JP)

(72) Inventors: Kimiharu Mizusaki, Wako-shi (JP); Yuki Imamura, Wako-shi (JP); Norihisa Kobayashi, Wako-shi (JP); Takaaki Mitsuoka, Wako-shi (JP)

(21) Appl. No.: 16/270,626

(22) Filed: Feb. 8, 2019

(30) Foreign Application Priority Data
Feb. 14, 2018 (JP) 2018-023623

(51) Int. Cl. H01M 8/2475; H01M 8/248; H01M 8/2484; B60L 50/71; B60L 50/72

(52) U.S. Cl. CPC H01M 8/2475; H01M 8/248; H01M 2250/20; B60L 50/71; B60L 50/72; H01M 8/2484

(57) ABSTRACT

A fuel cell system includes a stack case containing a fuel cell stack and an auxiliary device case containing fuel cell auxiliary devices. An internal space of the stack case and an internal space of the auxiliary device case are divided by a wall. Ventilation passages are formed in an upper part of the wall in a vertical direction. The ventilation passages connect the internal space of the stack case and the internal space of the auxiliary device case together. Ventilation ducts are connected to an upper part of the stack case in the vertical direction and an upper part the auxiliary device case in the vertical direction.

### CROSS-REFERENCE TO RELATED APPLICATION

This application is based upon and claims the benefit of priority from Japanese Patent Application No. 2018-023623 filed on Feb. 14, 2018, the contents of which are incorporated herein by reference.

### BACKGROUND OF THE INVENTION

### Field of the Invention

The present invention relates to a fuel cell system including ventilation structure of a stack case.

### Description of the Related Art

For example, a solid polymer electrolyte fuel cell employs a membrane electrode assembly (MEA). The membrane electrode assembly includes an electrolyte membrane, an anode provided on one side of the electrolyte membrane, and a cathode provided on the other side of the electrolyte membrane. The electrolyte membrane is a polymer ion exchange membrane. The membrane electrode assembly is sandwiched between separators to form a power generation cell. In the fuel cell, in general, a predetermined number of power generation cells are stacked together to form, e.g., an in-vehicle fuel cell stack mounted in a fuel cell vehicle.

In the fuel cell vehicle, in particular, hydrogen as a fuel gas may be leaked into the space for mounting the fuel cell stack. Under the circumstances, in an attempt to discharge the hydrogen leaked from the fuel cell stack to the outside efficiently, for example, a fuel cell vehicle as disclosed in Japanese Laid-Open Patent Publication No. 2015-193370 has been proposed. Japanese Laid-Open Patent Publication No. 2015-193370 discloses structure where a ventilation duct (exhaust duct) is connected to a stack case containing a fuel cell stack, and hydrogen is discharged from the stack case to the outside of the vehicle through the ventilation duct.

### SUMMARY OF THE INVENTION

In Japanese Laid-Open Patent Publication No. 2015-193370, the ventilation duct is connected to the stack case. However, in the case of adopting structure where an auxiliary device case containing, e.g., hydrogen system auxiliary devices (injector, etc.) is provided adjacent to, and joined to the stack case, the layout of the vehicle is restricted, and it may not be possible to determine the layout of the vehicle freely. Further, it is necessary to achieve the desired ventilation performance in the auxiliary device case.

The present invention has been made taking such problems into consideration, and an object of the present invention is to provide a fuel cell system in which, in the case where the fuel cell system is mounted in a vehicle, it is possible to determine the layout of the vehicle more freely, and improve the ventilation performance in the auxiliary device case.

In order to achieve the above object, the present invention provides a fuel cell system including a fuel cell stack, a stack case containing the fuel cell stack, and an auxiliary device case containing a fuel cell auxiliary device, wherein the auxiliary device case is provided adjacent to the stack case in a horizontal direction, and joined to the stack case, and wherein an internal space of the stack case and an internal space of the auxiliary device case are divided by a wall, a ventilation passage is provided on an upper part of the wall in a vertical direction, and the ventilation passage connects the internal space of the stack case and the internal space of the auxiliary device case together, and ventilation ducts are connected to an upper part of the stack case in the vertical direction and an upper part of the auxiliary device case in the vertical direction, respectively.

Preferably, the ventilation duct is connected to a corner of the upper part of the auxiliary device case in the vertical direction, opposite to a side connected to the stack case.

Preferably, the ventilation duct is connected to the two corners of the upper part of the auxiliary device case in the vertical direction.

Preferably, the ventilation duct is connected to a corner of the upper part of the stack case in the vertical direction, opposite to a side connected to the auxiliary device case.

Preferably, the ventilation duct is connected to the two corners of the upper part of the stack case in the vertical direction.

Preferably, the ventilation duct connected to the stack case and the ventilation duct connected to the auxiliary device case are connected together.

Preferably, the ventilation duct connected to the stack case and the ventilation duct connected to the auxiliary device case are connected together on one side in a direction perpendicular to a direction in which the stack case and the auxiliary device case are connected together.

Preferably, part of the auxiliary device case functions as an end plate which applies a tightening load to the fuel cell stack in a stacking direction.

Preferably, the ventilation passage is provided at least at each of both ends of upper part of the auxiliary device case.

Preferably, a case unit made up of the stack case and the auxiliary device case has a rectangular shape in a plan view, and the ventilation ducts are connected to four corners of the case unit in the plan view.

In the fuel cell system of the present invention, the internal space of the stack case and the internal space of the auxiliary device case are divided by the wall, the ventilation passage is provided at the upper position of the wall in the vertical direction, and the ventilation passage connects the internal space of the stack case and the internal space of the auxiliary device case together, the ventilation ducts are connected to the upper part of the stack case in the vertical direction and the upper part of the auxiliary device case in the vertical direction, respectively. In the structure, in the case where the fuel cell system is mounted in a vehicle, it is possible to determine the layout of the vehicle more freely, and improve the ventilation performance in the auxiliary device case.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view showing a fuel cell vehicle equipped with a fuel cell system according to an embodiment of the present invention;

FIG. 2 is an exploded perspective view showing a power generation cell; and

FIG. 3 is an exploded perspective view showing a case unit.

### DESCRIPTION OF THE PREFERRED EMBODIMENTS

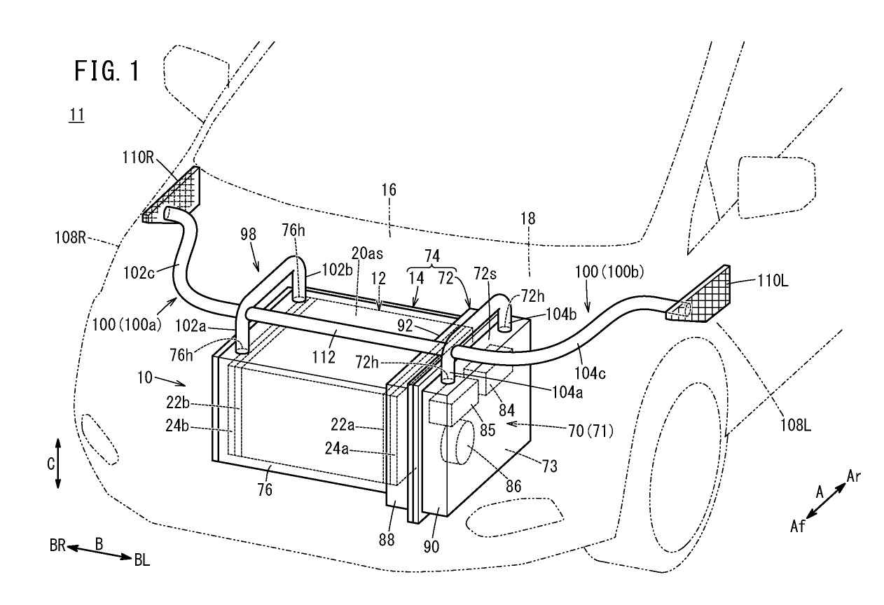

As shown in FIG. 1, for example, a fuel cell vehicle 11 equipped with a fuel cell system 10 according to an embodiment of the present invention is a fuel cell electric automobile. In the following description the “upper direction (upper part (position))” means the “upper direction (upper part (position))” in the vertical direction. In the fuel cell vehicle 11, a stack case 14 containing a fuel cell stack 12 is provided in a front room (motor room) 18 formed on the front side of a dashboard 16 (in a direction indicated by an arrow Af).

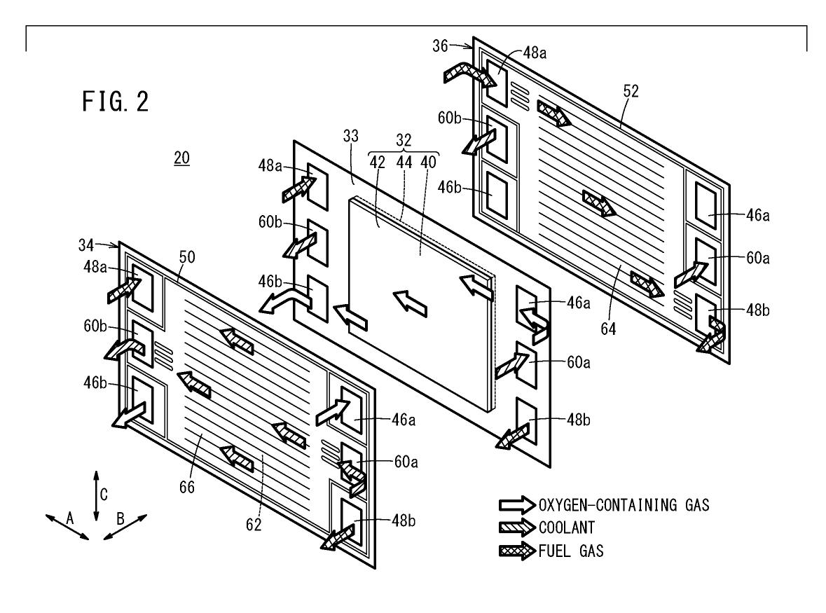

The fuel cell stack 12 includes a cell stack body 20as formed by stacking a plurality of power generation cells 20 (see FIG. 2) in a vehicle width direction (indicated by an arrow B). A first terminal plate 22a is provided at one end of the cell stack body 20as in a stacking direction (indicated by an arrow BL). A first insulating plate 24a is provided outside the first terminal plate 22a. At the other end of the cell stack body 20as in the stacking direction (indicated by an arrow BR), a second terminal plate 22b is provided. A second insulating plate 24b is provided outside the second terminal plate 22b. The fuel cell stack 12 is held between a right side panel 78 of the stack case 14 described later and a first case member 88 of an auxiliary device case 72 (through an unillustrated spacer), and a tightening load is applied to the fuel cell stack 12 in the stacking direction.

As shown in FIG. 2, the power generation cell 20 includes a membrane electrode assembly 32 and a first separator 34 and a second separator 36 sandwiching the membrane electrode assembly 32 from both sides. The membrane electrode assembly 32 includes an electrolyte membrane 40, and a cathode 42 and an anode 44 on both sides of the electrolyte membrane 40. A resin frame member 33 in the form of a film is provided over the entire outer peripheral portion of the membrane electrode assembly 32. The first separator 34 and the second separator 36 are metal separators or carbon separators.

At one end of the power generation cell 20 in a direction indicated by an arrow A, an oxygen-containing gas supply passage 46a, a coolant supply passage 60a, and a fuel gas discharge passage 48b are arranged in a direction indicated by an arrow C (vertical direction). The oxygen-containing gas supply passage 46a, the coolant supply passage 60a, and the fuel gas discharge passage 48b extend through the power generation cell 20 in the stacking direction indicated by the arrow B. An oxygen-containing gas is supplied through the oxygen-containing gas supply passage 46a. A coolant is supplied through the coolant supply passage 60a, and a fuel gas such as a hydrogen-containing gas is discharged through the fuel gas discharge passage 48b.

At the other end of the power generation cell 20 in the direction indicated by the arrow A, a fuel gas supply passage 48a for supplying the fuel gas, a coolant discharge passage 60b for discharging the coolant, and an oxygen-containing gas discharge passage 46b for discharging the oxygen-containing gas are arranged in the direction indicated by the arrow C. The fuel gas supply passage 48a, the coolant discharge passage 60b, and the oxygen-containing gas discharge passage 46b extend through the power generation cell 20 in the direction indicated by the arrow B.

The first separator 34 has an oxygen-containing gas flow field 62 on its surface facing the membrane electrode assembly 32. The oxygen-containing gas flow field 62 is connected to the oxygen-containing gas supply passage 46a and the oxygen-containing gas discharge passage 46b. The second separator 36 has a fuel gas flow field 64 on its surface facing the membrane electrode assembly 32. The fuel gas flow field 64 is connected to the fuel gas supply passage 48a and the fuel gas discharge passage 48b.

A coolant flow field 66 is formed between the first separator 34 and the second separator 36 of the power generation cells 20 that are adjacent to each other. The coolant flow field 66 is connected to the coolant supply passage 60a and the coolant discharge passage 60b. Seal members 50, 52 are formed integrally with, or separately from the first separator 34 and the second separator 36. The seal members 50, 52 contact the resin frame members 33, respectively. Instead of the seal members 50, 52, bead seals may be formed on the first separator 34 and the second separator 36 by press forming, in a manner that the bead seals protrude toward the resin frame member 33.

As shown in FIG. 1, the fuel cell system 10 includes the stack case 14 containing the fuel cell stack 12 and an auxiliary device case 72 containing fuel cell auxiliary devices 70. The stack case 14 and the auxiliary device case 72 form a case unit 74. The case unit 74 made up of the stack case 14 and the auxiliary device case 72 has a rectangular shape (having long sides extending in the vehicle width direction) in a plan view.

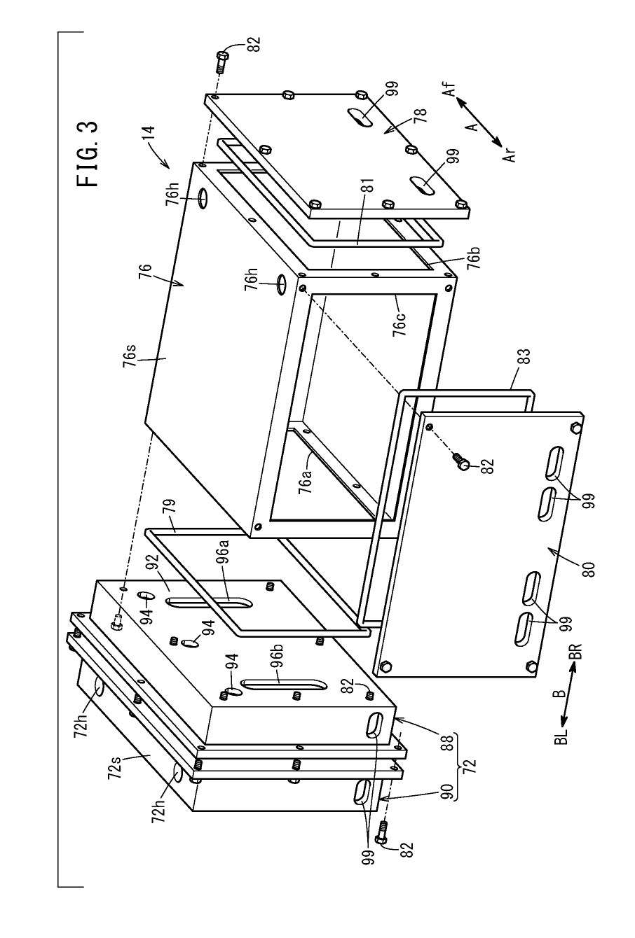

As shown in FIG. 3, the stack case 14 has a case body 76 having a rectangular shape in a plan view. The case body 76 has a rectangular left opening 76a formed on the left side (in a direction indicated by an arrow BL), a rectangular right opening 76b formed on the right side (in a direction indicated by an arrow BR, and a rectangular rear opening 76c formed on the rear side (in a direction indicated by an arrow Ar). The case body 76 has a box shape.

Holes 76h are formed at two corners of upper part of the case body 76 (in the illustrated embodiment, formed on an upper surface 76s of the case body 76 in the vertical direction), opposite to the side of the case body 76 to which the auxiliary device case 72 is joined. The stack case 14 is in fluid communication with the outside through the holes 76h. The hole 76h may be provided at only one of the two corners of the case body 76. The holes 76h may be formed on the upper part of the side surfaces, instead of the upper surface 76s of the stack case 14 in the vertical direction.

Further, the stack case 14 includes the right side panel 78 for closing the right opening 76b of the case body 76, and a rear side panel 80 for closing the rear opening 76c of the case body 76. The right side panel 78 is a rectangular panel, and the right side panel 78 is joined to a right end of the case body 76 using bolts 82. The right side panel 78 also functions as one of the end plates which applies the tightening load to the fuel cell stack 12 (FIG. 1) in the stacking direction. A seal member 81 made of elastic material is provided between the case body 76 and the right side panel 78. The seal member 81 is provided over the entire periphery of the joint surface between the case body 76 and the right side panel 78.

The rear side panel 80 is a rectangular panel, and the rear side panel 80 is joined to the rear end of the case body 76 using bolts 82. A seal member 83 made of elastic material is provided between the case body 76 and the rear side panel 80. The seal member 83 is provided over the entire periphery of the joint surface between the case body 76 and the rear side panel 80. The rear side panel 80 may not be a component part provided separately from the case body 76. The rear side panel 80 may be provided integrally with the case body 76.

As shown in FIG. 1, the auxiliary device case 72 is a protection case for protecting the fuel cell auxiliary devices 70. The auxiliary device case 72 is provided adjacent to the stack case 14 in the horizontal direction, and joined to the stack case 14. As the fuel cell auxiliary devices 70, hydrogen system auxiliary devices (hydrogen gas supply devices) 71 are placed in the auxiliary device case 72. An injector 84, an ejector 85, a hydrogen pump 86, and valves (not shown) are examples of the hydrogen system auxiliary devices 71. The auxiliary device case 72 includes the recessed first case member 88 provided adjacent to the stack case 14, and a recessed second case member 90 joined to the first case member 88. A storage space 73 containing the hydrogen system auxiliary devices 71 is formed by the first case member 88 and the second case member 90.

As shown in FIG. 3, the first case member 88 has a wall 92 (bottom wall of the first case member 88 having the recessed shape) joined to the case body 76. The first case member 88 is joined to a left end of the case body 76 using bolts 82. A seal member 79 made of elastic seal material is provided between the case body 76 and the first case member 88. The seal member 79 is provided over the entire periphery of the joint surface between the case body 76 and the first case member 88. The first case member 88 (part of the auxiliary device case 72) also functions as the other of the end plates which applies the tightening load to the fuel cell stack 12 (FIG. 1) in the stacking direction.

The internal space of the stack case 14 and the internal space of the auxiliary device case 72 are divided by the wall 92 of the first case member 88. A plurality of ventilation passages 94 are provided at upper positions of the wall 92. The ventilation passages 94 connect the internal space of the stack case 14 and the internal space of the auxiliary device case 72. The ventilation passages 94 are holes penetrating through the wall 92 in the thickness direction indicated by the arrow B. The ventilation passages 94 open in the left opening 76a of the case body 76. The seal member 79 is provided outside the ventilation passages 94.

The ventilation passages 94 are arranged at intervals in the horizontal direction indicated by the arrow A which is perpendicular to the direction indicated by the arrow B in which the stack case 14 and the auxiliary device case 72 are joined together. The ventilation passages 94 are provided at least on both sides at upper positions of the auxiliary device case 72 (on both sides of the auxiliary device case 72 in the horizontal direction perpendicular to the direction in which the stack case 14 and the auxiliary device case 72 are joined together).

Piping openings 96a, 96b are formed in the wall 92 of the first case member 88. Connection pipes (not shown) are inserted into the piping openings 96a, 96b, and connected to the oxygen-containing gas supply passage 46a, the oxygen-containing gas discharge passage 46b, the fuel gas supply passage 48a, the fuel gas discharge passage 48b, the coolant supply passage 60a, the coolant discharge passage 60b formed in the fuel cell stack 12 (FIG. 2).

The second case member 90 is a cover member for closing the first case member 88, and the second case member 90 is joined to the first case member 88 using bolts 82. Holes 72h are formed at two corners of upper part of the auxiliary device case 72 (in the illustrated embodiment, formed on an upper surface 72s of the auxiliary device case 72 in the vertical direction), opposite to the side to which the stack case 14 is joined. The auxiliary device case 72 is in fluid communication with the outside through the holes 72h. Specifically, the holes 72h are formed at two corners of the upper part of the second case member 90. The hole 72h may be provided at only one of the two corners of the upper part of the second case member 90. The holes 72h may be provided at the upper part of the side surface other than the upper surface 72s of the second case member 90 in the vertical direction.

As shown in FIG. 1, the fuel cell system 10 includes an exhaust apparatus 98 for discharging a fuel gas from the case unit 74 (the stack case 14 and the auxiliary device case 72). As shown in FIG. 3, in order to supply the air into the stack case 14 from the outside, and ventilate the internal space of the stack case 14, ventilation air inlet holes 99 are formed in the stack case 14. A plurality of the ventilating air inlet holes 99 are provided at lower positions of the stack case 14 (in the illustrated embodiment, lower positions of the right side panel 78 and lower positions of the rear side panel 80). Further, the ventilation air inlet holes 99 are also provided at the lower positions of the auxiliary device case 72 (in the illustrated embodiment, lower positions of the first case member 88 and lower positions of the second case member 90).

In FIG. 1, the exhaust apparatus 98 includes ventilation ducts 100a, 100b connected to the case unit 74. The ventilation ducts 100a, 100b are connected to four corners of the case unit 74 in a plan view. Specifically, the exhaust apparatus 98 has a first ventilation duct 100a connected to the stack case 14, and a second ventilation duct 100b connected to the auxiliary device case 72.

The first ventilation duct 100a is connected to the holes 76h provided for the stack case 14. Therefore, the first ventilation duct 100a is connected to two corners of the upper part of the stack case 14, opposite to the side connected to the auxiliary device case 72. The first ventilation duct 100a includes two connection pipes 102a, 102b connected to the two holes 76h of the stack case 14, and a merge pipe 102c. The two connection pipes 102a, 102b are merged together into the merge pipe 102c. The merge pipe 102c is connected to a right exhaust port 110R provided in a right fender 108R.

The second ventilation duct 100b is connected to the holes 72h formed in the auxiliary device case 72. Therefore, the second ventilation duct 100b is connected to the two corners of the upper part of the auxiliary device case 72, opposite to the side to which the stack case 14 is connected. The second ventilation duct 100b includes two connection pipes 104a, 104b connected to the two holes 72h of the auxiliary device case 72, and a merge pipe 104c. The two connection pipes 104a, 104b are merged together into the merge pipe 104c. The merge pipe 104c is connected to a left exhaust port 110L provided in a left fender 108L.

The first ventilation duct 100a and the second ventilation duct 100b are connected together through a coupling pipe 112. The coupling pipe 112 is connected to the connection pipe 102a on the front side of the first ventilation duct 100a, and connected to the connection pipe 104a of the front side of the second ventilation duct 100b. Therefore, the first ventilation duct 100a and the second ventilation duct 100b are connected together, on one side (front side) in a direction (indicated by the arrow A) perpendicular to the direction in which the stack case 14 and the auxiliary device case 72 are connected together in a plan view. The coupling pipe 112 may be connected to the connection pipe 102b on the rear side of the first ventilation duct 100a and the connection pipe 104b on the rear side of the second ventilation duct 100b.

Operation of the fuel cell vehicle 11 having the above structure will be described.

At the time of operating the fuel cell vehicle 11 shown in FIG. 1, a fuel gas, an oxygen-containing gas, and a coolant are supplied to the fuel cell stack 12. As shown in FIG. 2, the fuel gas flows from the fuel gas supply passage 48a into the fuel gas flow field 64 of the second separator 36. This fuel gas is supplied along the anode 44 of the membrane electrode assembly 32. The oxygen-containing gas flows from the oxygen-containing gas supply passage 46a into the oxygen-containing gas flow field 62 of the first separator 34. The oxygen-containing gas is supplied along the cathode 42 of the membrane electrode assembly 32.

Thus, in the membrane electrode assembly 32, the fuel gas supplied to the anode 44 and the oxygen-containing gas supplied to the cathode 42 are partially consumed in electrochemical reactions at the electrode catalyst layers to generate electricity. Then, the fuel gas is discharged from the fuel gas discharge passage 48b. The oxygen-containing gas is discharged from the oxygen-containing gas discharge passage 46b.

In the meanwhile, the coolant is supplied to the coolant supply passage 60a, and the flows into the coolant flow field 66 between the first separator 34 and the second separator 36. After the coolant cools the membrane electrode assembly 32, the coolant is discharged through the coolant discharge passage 60b.

In FIG. 1, in the case where leakage of the fuel gas from the fuel cell stack 12 into the stack case 14 occurs, or in the case where leakage of the fuel gas from the hydrogen system auxiliary device 71 into the auxiliary device case 72 occurs, the fuel gas flows from the right and left exhaust ports 110R, 110L to the outside of the vehicle through the exhaust apparatus 98 (the first ventilation duct 100a and the second ventilation duct 100b).

In this case, the fuel cell system 10 according to the embodiment of the present invention offers the following advantages.

In the fuel cell system 10 of the present invention, the internal space of the stack case 14 and the internal space of the auxiliary device case 72 is divided by the wall 92, and the ventilation passages 94 are formed on the upper part of the wall 92. The ventilation passages 94 connect the internal space of the stack case 14 and the internal space of the auxiliary device case 72 together. The ventilation ducts 100 (the first ventilation duct 100a and the second ventilation duct 100b) are connected to the upper part of the stack case 14 and the upper part of the auxiliary device case 72. In the structure, in the case where the fuel cell system 10 is mounted in the vehicle, it is possible to determine the layout more freely. Further, it is possible to improve the ventilation performance in the auxiliary device case 72.

The first ventilation duct 100a is connected to the corner of the upper part of the stack case 14, opposite to the side to which the auxiliary device case 72 is connected. In the structure, even in the case where the fuel cell vehicle 11 is inclined at an angle where the auxiliary device case 72 is provided at a lower position, it is possible to efficiently discharge the fuel gas through the first ventilation duct 100a. Further, the first ventilation duct 100a is connected to the two corners of the upper part of the stack case 14. Therefore, even in the case where the fuel cell vehicle 11 is inclined in a manner that the position of one of the two corners becomes relatively low and the position of the other of the two corners becomes relatively high, it is possible to discharge the fuel gas efficiently through the first ventilation duct 100a.

In the upper position of the auxiliary device case 72, the second ventilation duct 100b is connected to the corner, opposite to the side to which the stack case 14 is connected. In the structure, even in the case where the fuel cell vehicle 11 is inclined at an angle where the stack case 14 is provide at a lower position, it is possible to efficiently discharge the fuel gas through the second ventilation duct 100b. Further, since the second ventilation duct 100b is connected to the two corners of the upper part of the auxiliary device case 72, even if the fuel cell vehicle 11 is inclined in a manner that the position of one of the two corners becomes relatively low, and the position of the other of the two corners becomes relatively high, it is possible to discharge the fuel gas efficiently through the second ventilation duct 100b.

The first ventilation duct 100a connected to the stack case 14 and the second ventilation duct 100b connected to the auxiliary device case 72 are connected together. In the structure, it is possible to discharge the fuel gas more efficiently.

The first ventilation duct 100a connected to the stack case 14 and the second ventilation duct 100b connected to the auxiliary device case 72 are connected together on one side (front side) in the direction indicated by the arrow A perpendicular to the direction in which the stack case 14 and the auxiliary device case 72 are connected together in a plan view. In the structure, the length of the coupling pipe 112 connecting the first ventilation duct 100a and the second ventilation duct 100b can be reduced. Further, in the case where the other devices are provided above the stack case 14, these other devices can be provided at positions where the coupling pipe 112 is not present. Therefore, it is possible to determine the layout more freely.

Part of the auxiliary device case 72 (first case member 88) also functions as the end plate which applies the tightening load to the fuel cell stack 12 in the stacking direction. Accordingly, it is possible to streamline/simplify the structure.

The ventilation passages 94 are provided at least at both ends of the upper positions of the auxiliary device case 72. In the structure, even if the fuel cell vehicle 11 is inclined, the fuel gas can move between the internal space of the auxiliary device case 72 and the internal space of the stack case 14 through any of the ventilation passages 94. Accordingly, it is possible to discharge the fuel gas efficiently.

In the embodiment of the present invention described above, the fuel cell system 10 is mounted in the fuel cell vehicle 11 in a manner that the stacking direction of the fuel cell stack 12 is oriented in the vehicle width direction indicated by the arrow B. Alternatively, the fuel cell system 10 may be mounted in the fuel cell vehicle 11 in a manner that the stacking direction of the fuel cell stack 12 is oriented in the front/rear direction of the fuel cell vehicle 11 indicated by the arrow A. In the embodiment of the present invention described above, the fuel cell system 10 is mounted in the fuel cell vehicle 11 in a manner that the stack case 14 is provided on the right side, and the auxiliary device case 72 is provided on the left side. Alternatively, the fuel cell system 10 may be mounted in the fuel cell vehicle 11 in a manner that the stack case 14 is provided on the left side, and the auxiliary device case 72 is provided on the right side.

The present invention is not limited to the embodiment described above, and various modifications may be made without departing from the gist of the present invention.

What is claimed is:

1. A fuel cell system comprising:
a fuel cell stack;
a stack case containing the fuel cell stack; and
an auxiliary device case containing a fuel cell auxiliary device,
wherein the auxiliary device case is provided adjacent to the stack case in a horizontal direction, and joined to the stack case, and
wherein an internal space of the stack case and an internal space of the auxiliary device case are divided by a wall, a ventilation passage is provided on an upper part of the wall in a vertical direction, and the ventilation passage connects the internal space of the stack case and the internal space of the auxiliary device case together; and
ventilation ducts are connected to an upper part of the stack case in the vertical direction and an upper part of the auxiliary device case in the vertical direction, respectively.

2. The fuel cell system according to claim 1, wherein the ventilation duct is connected to a corner of the upper part of the auxiliary device case in the vertical direction, opposite to a side connected to the stack case.

3. The fuel cell system according to claim 2, wherein the ventilation duct is connected to the two corners of the upper part of the auxiliary device case in the vertical direction.

4. The fuel cell system according to claim 1, wherein the ventilation duct is connected to a corner of the upper part of the stack case in the vertical direction, opposite to a side connected to the auxiliary device case.

5. The fuel cell system according to claim 4, wherein the ventilation duct is connected to the two corners of the upper part of the stack case in the vertical direction.

6. The fuel cell system according to claim 1, wherein the ventilation duct connected to the stack case and the ventilation duct connected to the auxiliary device case are connected together.

7. The fuel cell according to claim 6, wherein the ventilation duct connected to the stack case and the ventilation duct connected to the auxiliary device case are connected together on one side in a direction perpendicular to a direction in which the stack case and the auxiliary device case are connected together.

8. The fuel cell system according to claim 1, wherein part of the auxiliary device case functions as an end plate which applies a tightening load to the fuel cell stack in a stacking direction.

9. The fuel cell system according to claim 1, wherein the ventilation passage is provided at least at each of both ends of upper part of the auxiliary device case.

10. The fuel cell system according to claim 1, wherein a case unit made up of the stack case and the auxiliary device case has a rectangular shape in a plan view; and
the ventilation ducts are connected to four corners of the case unit in the plan view.

11. The fuel cell system according to claim 1, wherein the auxiliary device case includes a first case member having the wall and joined to the stack case, and a second case member joined to the first case member, on a side of the first case member opposite to the stack case; and
the ventilation passage is provided in the first case member.

12. The fuel cell system according to claim 11, wherein the ventilation duct is connected to the second case member.
